(19) United States
(12) Patent Application Publication
(10) Pub. No.: US 2026/0092649 A1
(43) Pub. Date: Apr. 2, 2026

(54) VALVE APPARATUS

(71) Applicant: CKD CORPORATION, Komaki-shi (JP)

(72) Inventors: Osamu SUEMATSU, Komaki-shi (JP); Syun Nishizawa, Komaki-shi (JP)

(73) Assignee: CKD CORPORATION, Komaki-shi (JP)

(21) Appl. No.: 19/330,508

(22) Filed: Sep. 16, 2025

(30) Foreign Application Priority Data
Sep. 27, 2024 (JP) 2024-168030

(51) Int. Cl. F16K 1/48; F16K 1/02; F16K 1/46; F16K 37/00

(52) U.S. Cl. CPC F16K 1/48; F16K 1/02; F16K 1/46; F16K 37/0058

(57) ABSTRACT

A needle valve includes a linear stepping motor that has a shaft and performs a linear motion of the shaft, an annular valve seat whose axis is parallel to the direction of the linear motion, and a needle valve element that performs a forward/backward motion in the same direction as the linear motion of the shaft with respect to the annular valve seat in accordance with the linear motion of the shaft. The shaft and the needle valve element are connected to each other by engagement of a male screw part of the shaft and a female screw part of the needle valve element, with a degree of freedom in a radial direction orthogonal to the axis of the male screw part.

### CROSS-REFERENCE TO RELATED APPLICATIONS

This application is based upon and claims the benefit of priority to Japanese Patent Application No. 2024-168030 filed on September 27, 2024, the entire contents of which are incorporated herein by reference.

### BACKGROUND

### Technical Field

The disclosure relates to a valve apparatus including a drive source provided with a shaft and configured to perform a linear motion of the shaft, an annular valve seat with an axial direction parallel to the direction of the linear motion, and a valve element configured to perform a forward/backward motion in the same direction as the linear motion with respect to the annular valve seat in accordance with the linear motion.

### Related Art

Conventionally, an electrically-operated flow regulating valve has been used for controlling a flow rate of a fluid, such as compressed air and water, in general industrial machines. As the flow regulating valve, for example, a needle valve 100 shown in FIG. 6 and a needle valve 200 shown in FIG. 7 have been known.

The needle valve 100 shown in FIG. 6 is configured such that a valve body 101 and a drive unit 102 are stacked one on the other in an upward/downward direction, i.e., in a vertical direction. This vertical direction is parallel to the direction of a forward/backward motion, i.e., an advancing/retracting motion, of a needle valve element with respect to an annular valve seat.

The valve body 101 is provided with an inflow passage 103 for allowing a control fluid to flow in the valve body 101 and an outflow passage 104 for allowing the control fluid to flow out of the valve body 101. The valve body 101 internally includes a valve chamber 105 connecting the inflow passage 103 and the outflow passage 104. Furthermore, the valve body 101 includes an annular valve seat 106 at a junction between the inflow passage 103 and the valve chamber 105.

In the valve chamber 105, a needle valve element 107 is installed. The needle valve element 107 includes a columnar body part 107a. The axial direction of this body part 107a is coincident with the forward/backward direction. The body part 107a is inserted through a guide part 108 provided in the valve body 101 so that the forward/backward motion of the needle valve element 107 is guided by the guide part 108. An O-ring 115 seals the space between the body part 107a and the guide part 108. The body part 107a has, on its end near the annular valve seat 106, a reduced-diameter part 107b whose diameter decreases toward the annular valve seat 106. When the needle valve element 107 performs the forward/backward motion in the downward/upward direction, i.e., in the vertical direction, the clearance between the outer peripheral surface of the reduced-diameter part 107b and the annular valve seat 106 (i.e., the opening degree of the needle valve 100) is increased or decreased.

The drive unit 102 is provided with a cylinder housing 109 and a linear stepping motor 110 (hereinafter, simply referred to as a motor 110) fixed to the cylinder housing 109. The motor 110 has a shaft 111 that performs a linear motion in the vertical direction. The shaft 111 is inserted in the cylinder housing 109. The distal end part of the shaft 111 is rigidly connected to the needle valve element 107 inside the cylinder housing 109. For this connection, adhesive, nuts, or others are used. Since the shaft 111 and the needle valve element 107 are connected as above, when the shaft 111 is moved in a protruding direction, i.e., in a downward direction, the needle valve element 107 is moved together with the shaft 111 in a direction to come close to the annular valve seat 106, i.e., in a valve-closing direction. In contrast, when the shaft 111 is moved in a retracting direction, i.e., in an upward direction, the needle valve element 107 is lifted upward with the shaft 111 and moved in a direction to separate from the annular valve seat 106, i.e., in a valve-opening direction. Since the shaft 111 and the needle valve element 107 are rigidly fixed to each other, the needle valve element 107 reliably follows the motion of the shaft 111 and performs the forward/backward motion.

Next, the needle valve 200 shown in FIG. 7 will be described with a focus on differences from the needle valve 100. In the needle valve 200, a shaft 112 of a motor 110 and a needle valve element 113 are not rigidly connected, and the needle valve element 113 is urged toward the shaft 112 by a compression coil spring 114, thereby maintaining a contact state of an upper end face 113a of the needle valve element 113 with a distal end face 112a of the shaft 112. Accordingly, when the shaft 112 is moved in the protruding direction, i.e., in the downward direction, the needle valve element 113 pressed by the shaft 112 is moved in the valve-closing direction against the elastic force of the compression coil spring 114. On the other hand, when the shaft 112 is moved in the retracting direction, i.e., in the upward direction, the needle valve element 113 is moved in the valve-opening direction by the elastic force of the compression coil spring 114 so as to follow the shaft 112.

The needle valve 100, 200 is configured such that the needle valve element 107, 113 performs the forward/backward motion in accordance with the linear motion of the shaft 111, 112. With this forward/backward motion, the clearance between the needle valve element 107, 113 and the annular valve seat 106 can be adjusted, that is, the opening degree of the needle valve 100, 200 can be adjusted, thereby regulating the flow rate of the control fluid. In the following description, among the connection methods between the shaft 111, 112 and the needle valve element 107, 113, a method for rigidly connecting the shaft 111 and the needle valve element 107 as in the needle valve 100 is referred to as a “rigid connecting type”, and a method for maintaining a contact state of the shaft 112 and the needle valve element 113 by the compression coil spring 114, where the shaft 112 and the needle valve element 113 are not rigidly connected, as in the needle valve 200 is referred to as a “separate pressing type”. As the needle valve of the separate pressing type, for example, a needle valve disclosed in Japanese unexamined patent application publication No. 2006-153204 is known.

### SUMMARY

### Technical Problems

The connection methods between the shaft 111 and the needle valve element 107 and between the shaft 112 and the needle valve element 113 in the above-mentioned conventional arts would cause the following problems.

The problems in the rigid connecting type will be described first. In the needle valve 100 configured as above, it is desired that the central axis of the needle valve element 107 inserted through the guide part 108 and the central axis of the shaft 111 of the motor 110 fixed to the cylinder housing 109 are positioned coaxially, i.e., aligned with each other. However, for example, due to manufacturing tolerances and other reasons, the central axis of the needle valve element 107 and the central axis of the shaft 111 may be misaligned and not coaxial. While the central axes are misaligned as above, when the needle valve element 107 rigidly connected to the shaft 111 performs the forward/backward motion, the sliding resistance between the needle valve element 107 and the guide part 108 increases, thus increasing the load on the motor 110. For this reason, a motor with greater output power, i.e., a large motor, may be required. Further, if the above-mentioned misalignment of the central axes occurs, the O-ring 115 will not be compressed uniformly over its entire circumference, which may deteriorate the sealing performance or cause uneven abrasion.

The problems in the separate pressing type will be described below. This separate pressing type causes no problem with the central axis misalignment mentioned above. However, the movement of the needle valve element 113 in the valve-opening direction relies on the elastic force of the compression coil spring 114 and, if the O-ring 115 sticks to the inner peripheral surface of the guide part 108, the compression coil spring 114 will not be able to move the needle valve element 113 in the valve-opening direction even when the shaft 112 moves in the retracting direction. In other words, the accuracy of adjusting the opening degree of the needle valve 200 may deteriorate, that is, the accuracy of regulating the flow rate of a control fluid may decrease. To ensure that the needle valve element 113 moves in the valve-opening direction, it is conceivable to use a compression coil spring 114 with stronger elastic force. However, this would require a motor 110 that can output greater power to move the needle valve element 113 in the valve-closing direction. This is undesirable because such a motor 110 should be increased in size.

The present disclosure has been made to address the above problems and has a purpose to provide a valve apparatus capable of reliably performing a forward/backward motion of a needle valve element as in the rigid connecting type, not in the separate pressing type which causes a problem with misalignment of central axes of a shaft and a needle valve element.

### Means of Solving the Problems

To achieve the above-mentioned purpose, one aspect of the present disclosure provides the following configurations.

(1) A valve apparatus includes: a drive source provided with a shaft and configured to perform a linear motion of the shaft; an annular valve seat with an axial direction parallel to a direction of the linear motion; and a valve element configured to perform a forward/backward motion in the same direction as the linear motion with respect to the annular valve seat in accordance with the linear motion, wherein the shaft and the valve element are connected to each other by engagement of a first engagement part provided in the shaft and a second engagement part provided in the valve element with a degree of freedom in at least a perpendicular direction to the direction of the linear motion.

(2) The valve apparatus described in (1) may be configured such that the first engagement part is one of a male screw and a female screw, the second engagement part is another of the male screw and the female screw, and the first engagement part and the second engagement part are connected by threaded engagement with a play, and the degree of freedom is ensured by the play.

(3) The valve apparatus described in (1) or (2) may be configured such that the first engagement part and the second engagement part are engaged with each other with a degree of freedom in a parallel direction to the direction of the linear motion, and the valve apparatus further includes an urging member for urging the valve element toward the shaft.

(4) The valve apparatus described in any one of (1) to (3) may further include a positioning groove for positioning the drive source, wherein the positioning groove is a columnar space formed coaxially with the annular valve seat, the drive source includes a positioning part having a columnar shape, the positioning part being located on an inner circumference side of the positioning groove and formed coaxially with the shaft, and the valve apparatus is provided with an elastic member having a circular ring shape and being located in a clearance between an inner peripheral surface of the positioning groove and an outer peripheral surface of the positioning part.

(5) The valve apparatus described in any one of (1) to (4) may further include a guide part for guiding the forward/backward motion of the valve element, wherein the guide part is a columnar space formed coaxially with the annular valve seat, the valve element includes an inserted part having a columnar shape and being insertable in the guide part, and the valve apparatus is provided with a first elastic seal member and a second elastic seal member, each having a circular ring shape, located in a clearance between the guide part and the inserted part, the first elastic seal member and the second elastic seal member being arranged coaxially with each other and side by side in the same direction as the forward/backward motion of the valve element.

(6) In the valve apparatus described in (5), the first elastic seal member and the second elastic seal member may be arranged side by side in the same direction as the forward/backward motion of the valve element at a distance larger than a stroke amount of the forward/backward motion.

(7) In the valve apparatus described in (2), the valve element may be provided with an anti-rotation pin protruding from an axis of rotation of the valve element to suppress the rotation of the valve element in a loosening direction of the threaded engagement or an opposite direction.

(8) In the valve apparatus described in (7), the anti-rotation pin may be exposed to outside of the valve apparatus and serves as an indicator to visually confirm a position of the valve element in the direction of the forward/backward motion.

According to the valve apparatus of the disclosure, it is possible to reliably perform the forward/backward motion of the needle valve element as in the rigid connecting type, without causing a problem with misalignment of central axes of the shaft and the needle valve element as in the separate pressing type.

### BRIEF DESCRIPTION OF THE DRAWINGS

FIG. 1 is a cross-sectional view of a needle valve in an embodiment, showing a state where the needle valve is in a maximum valve-open state;

FIG. 2 is a cross-sectional view of the needle valve in the embodiment, showing a state where the needle valve is in a valve-closed state;

FIG. 3 is a plan view of the needle valve in the embodiment;

FIG. 4 is a graph showing flow rate characteristics of the needle valve in the embodiment;

FIG. 5 is a graph showing flow rate characteristics of the needle valve in the embodiment for a configuration not including a compression coil spring;

FIG. 6 is a cross-sectional view of a needle valve (of a rigid connecting type) in a conventional art; and

FIG. 7 is a cross-sectional view of a needle valve (of a separate pressing type) in a conventional art.

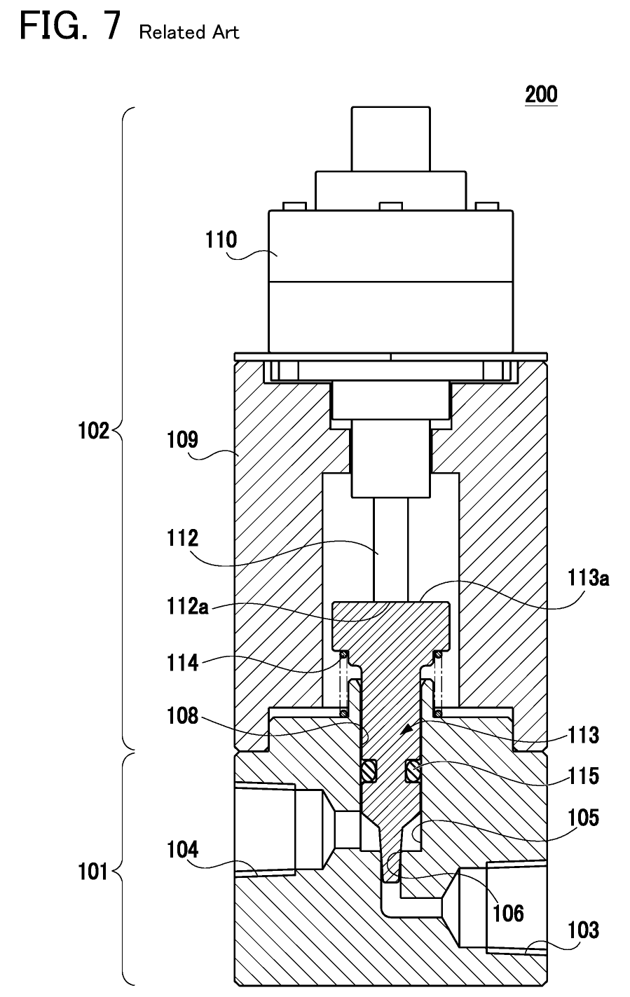

### DETAILED DESCRIPTION OF THE EXEMPLARY EMBODIMENTS

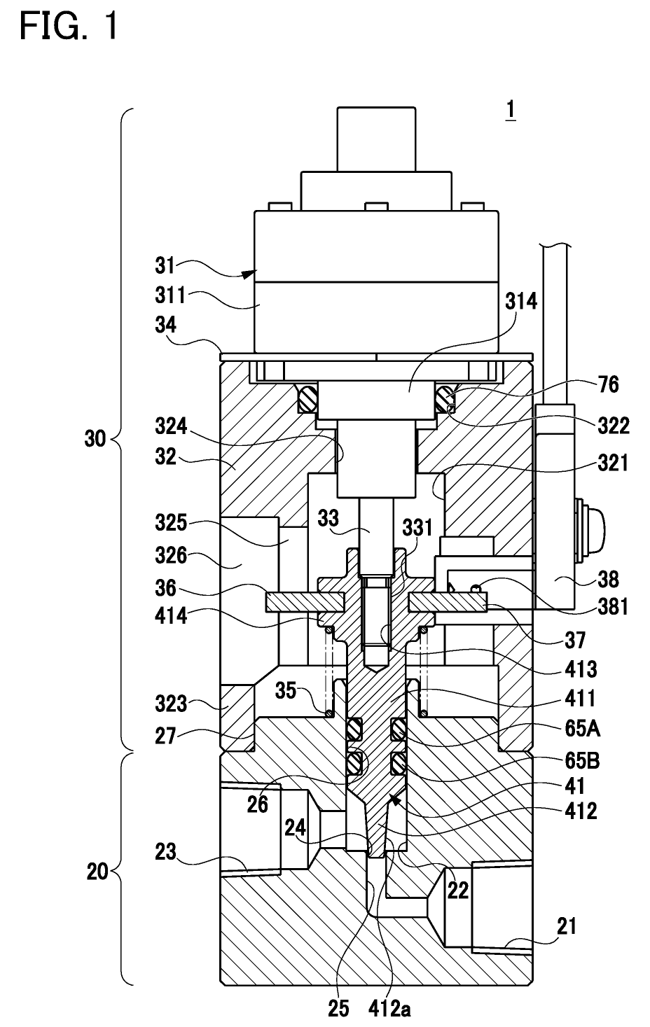

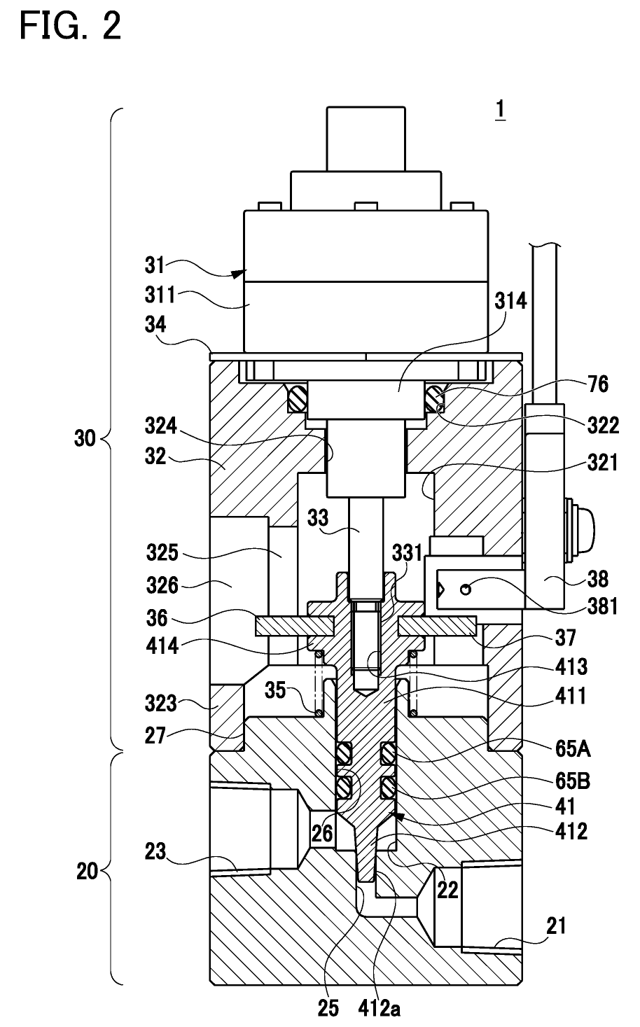

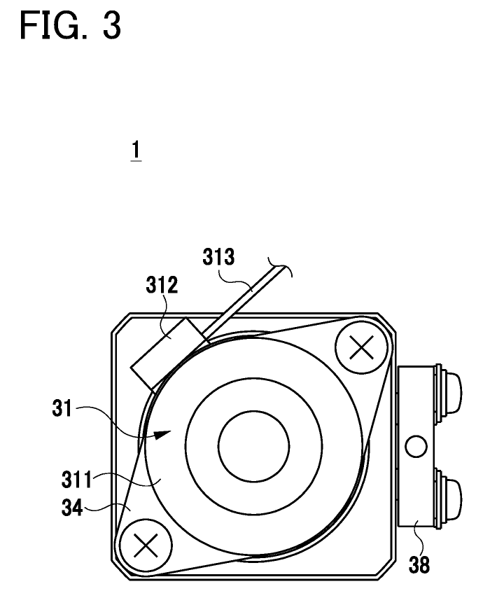

A detailed description of a needle valve 1 in an embodiment of this disclosure will now be given referring to the accompanying drawings. FIG. 1 is a cross-sectional view of the needle valve 1 in the present embodiment, showing a state where the needle valve 1 is in a maximum valve-open state. FIG. 2 is a cross-sectional view of the needle valve 1 in the present embodiment, showing a state where the needle valve 1 is in a valve-closed state. FIG. 3 is a plan view of the needle valve 1 in the present embodiment, that is, a view of the needle valve 1 shown in FIG. 1 or 2 as viewed from above. The figures used in the description are simplified for convenience of explanation and do not accurately show accrual shapes, dimensions, and others.

The needle valve 1 in the present embodiment is, for example, a valve apparatus configured to regulate a flow rate of a control fluid, such as compression air and water.

### Configuration of Needle Valve

The needle valve 1 is configured such that a valve body 20 and a drive unit 30 are stacked one on the other in a vertical direction, i.e., an upward/downward direction, in FIG. 1 and FIG. 2. This vertical direction is parallel to a direction in which a needle valve element 41 performs a forward/backward motion, i.e., an advancing/retracting motion, with respect to an annular valve seat 24, which will be described in detail later. The needle valve element 41 is one example of a valve element of the disclosure, which will be described in detail later.

The drive unit 30 is mainly composed of a linear stepping motor 31 (one example of a drive source of the disclosure) and a cylinder housing 32.

The cylinder housing 32 is made of metal material (e.g., aluminum, stainless steel, or others) or resin material and formed in a nearly rectangular parallelepiped shape by machining. The cylinder housing 32 is formed, at an outer circumferential edge of an end face (a lower end face) facing the valve body 20, with a protruding part 323 protruding toward the valve body 20, and the protruding part 323 engages in a positioning recess 27 of the valve body 20. An alternative may be configured such that the cylinder housing 32 is provided with a recess and the valve body 20 is provided with a protruding part, and the cylinder housing 32 and the valve body 20 engage with each other.

The cylinder housing 32 is formed, e.g., by drilling, with an accommodation part 321, which is the columnar space, extending from the lower end face facing the valve body 20 toward the opposite end face (i.e., the upper end face in the figure). The cylinder housing 32 is further formed, e.g., by drilling, with a positioning groove 322 as a columnar space, extending from the upper end face toward the lower end face to position the motor 31. This positioning groove 322 is provided at a position coaxial with the annular valve seat 24 while the cylinder housing 32 engages with the valve body 20 via the protruding part 323. The accommodation part 321 and the positioning groove 322 communicate with each other through an insertion hole 324.

On the upper end face of the cylinder housing 32, the linear stepping motor 31 (hereinafter, simply referred to as a motor 31) is fixed by a mounting metal piece 34.

The motor 31 is mainly composed of a columnar body part 311, a shaft 33, a positioning part 314, and a drive circuit 312 (see FIG. 3).

The shaft 33 protrudes from the body part 311 into the cylinder housing 32 and is inserted in the accommodation part 321 of the cylinder housing 32. The shaft 33 is caused to linearly move, i.e., perform a linear motion, in the vertical direction (i.e., the upward/downward direction) by the drive circuit 312. The drive circuit 312 is provided on the outer peripheral surface of the body part 311, as shown in FIG. 3. The drive circuit 312 receives an amount of movement, i.e., the number of steps, of the shaft 33 from a high controller (not shown) via a signal wire 313. Based on the input number of steps, the drive circuit 312 controls the linear motion of the shaft 33.

The shaft 33 is provided, at its distal end, with a male screw part 331 (one example of a first engagement part of the disclosure), with which a female screw part 413 of the needle valve element 41, mentioned later, is threadedly engaged with a play.

The positioning part 314 is provided on the end face (the lower end face) of the body part 311, facing the cylinder housing 32. The positioning part 314 is formed in a columnar shape and positioned coaxially with the shaft 33. The positioning part 314 is on the inner circumferential side of the positioning groove 322 of the cylinder housing 32. In a clearance between the inner peripheral surface of the positioning groove 322 and the outer peripheral surface of the positioning part 314, an O-ring 76 (one example of an elastic member of the disclosure) is placed. This O-ring 76 has a larger cross-sectional diameter, i.e., width, than the size of the clearance.

The valve body 20 is made of metal material (e.g., aluminum, stainless steel, etc.) or resin material and formed in a nearly rectangular parallelepiped shape by machining. The valve body 20 is provided, at the outer circumferential edge of the end face (the upper end face) facing the drive unit 30, with the positioning recess 27 that meshes with the protruding part 323 of the cylinder housing 32.

The valve body 20 is provided with an inflow passage 21 for allowing a control fluid to flow in the valve body 20 and an outflow passage 23 for allowing the control fluid to flow out of the valve body 20. The upper end face of the valve body 20 is provided, on the central axis of the valve body 20, with a valve chamber 22 formed, e.g., by drilling, toward the lower end face. The bottom face of the valve chamber 22 is provided with a valve hole 25 providing communication between the valve chamber 22 and the inflow passage 21, and further provided with an annular valve seat 24 surrounding the valve hole 25. The valve chamber 22 communicates with the outflow passage 23 on the lateral side. Thus, the control fluid flowing in the valve body 20 through the inflow passage 21 passes through the valve chamber 22 and flows out of the valve body 20 through the outflow passage 23.

In the valve chamber 22, the needle valve element 41 is installed. The needle valve element 41 is formed in a nearly columnar shape by injection molding or machining, and made of, for example, metal material (e.g., aluminum, stainless steel, etc.) or resin material.

The needle valve element 41 includes a body part 411 (one example of an inserted part of the disclosure) having a columnar shape. The axial direction of the body part 411 is coincident with the forward/backward direction, that is, the central axis of the body part 411 extends in the forward/backward direction.

Of both end parts of the body part 411 of the needle valve element 41 in the axial direction, one end part on the drive unit 30 side, i.e., an upper end part in the figure, is located inside the drive unit 30. In the end face of the body part 411 on the drive unit 30 side, i.e., an upper end face in the figure, is formed, e.g., by drilling, with the female screw part 413 (one example of a second engagement part of the disclosure) coaxially with the body part 411. In the female screw part 413, the male screw part 331 of the shaft 33 are connected by threaded engagement with a play, or clearance. This threaded engagement connects the needle valve element 41 and the shaft 33, allowing the needle valve element 41 to move forward and backward, i.e., to advance and retract, in accordance with the linear motion of the shaft 33.

Further, the play includes a play (backlash) in the direction of linear motion and the direction of forward/backward motion (i.e., the vertical direction) and a play in the perpendicular direction to the vertical direction, i.e., in the radial direction orthogonal to the axis of the male screw part 331. This play allows the needle valve element 41 to be connected to the shaft 33 with a degree of freedom in the vertical direction and the perpendicular direction.

Of both end parts of the body part 411 of the needle valve element 41 in the axial direction, the other end part on the annular valve seat 24 side, i.e., a lower end part in the figure, is provided with a reduced-diameter part 412 having the diameter decreasing toward the annular valve seat 24. The body part 411 is inserted through a guide part 26 provided in the valve body 20 and thus the forward/backward motion of the needle valve element 41 is guided by the guide part 26.

The guide part 26 is placed coaxially with the annular valve seat 24 and the valve hole 25. Accordingly, when the needle valve element 41 moves forward and backward along the guide part 26, the reduced-diameter part 412 of the needle valve element 41 is caused to move into and out of the valve hole 25. This movement of the reduced-diameter part 412 into or out of the valve hole 25 decreases or increases the clearance between the outer peripheral surface 412a of the reduced-diameter part 412 and the annular valve seat 24, that is, the opening degree of the needle valve 1.

Further, an O-ring 65A (one example of a first elastic seal member of the disclosure) and an O-ring 65B (one example of a second elastic seal member of the disclosure) are placed between the guide part 26 and the body part 411 to maintain the seal between the guide part 26 and the body part 411.

The O-ring 65A and the O-ring 65B are identical components and arranged coaxially with each other and side by side, i.e., in parallel, in the same direction as the forward/backward motion of the needle valve element 41. Further, grease is filled between the O-ring 65A and the O-ring 65B, allowing the needle valve element 41 to smoothly slide on the guide part 26. In addition, the distance between the O-ring 65A and the O-ring 65B is set larger than the stroke amount of the forward/backward motion of the needle valve element 41. This can suppress the grease from leaking to the outside of the O-ring 65A and the O-ring 65B (that is, above the O-ring 65A or below the O-ring 65B) when the needle valve element 41 moves forward and backward.

A part of the needle valve element 41, inserted in the accommodation part 321 of the cylinder housing 32, includes an increased-diameter part 414 having a larger diameter than other parts. A compression coil spring 35 is provided in a compressed state between the end face of the increased-diameter part 414, facing the valve body 20, that is, the lower end face, and the upper end face of the valve body 20. The compression coil spring 35 always urges the needle valve element 41 in a direction toward the shaft 33, i.e., in the upward direction in the figure.

The increased-diameter part 414 is formed, on its outer peripheral surface, with an anti-rotation pin 36 and an original-position detection pin 37, each protruding outward in the radial direction of the increased-diameter part 414.

The anti-rotation pin 36 is inserted in a slot 325 of the cylinder housing 32. Thus, the anti-rotation pin 36 prevents the needle valve element 41 from rotating in a direction of loosening the threaded engagement between the male screw part 331 and the female screw part 413 or the opposite direction thereto. This can suppress the position of the needle valve element 41 with respect to the shaft 33 in the vertical direction from changing. Thus, the needle valve 1 can have enhanced reliability of controlling the opening degree.

The tip of the anti-rotation pin 36 protrudes from the slot 325 to the outside of the needle valve 1 and is visible from the outside of the needle valve 1 through an opening 326 of the cylinder housing 32. Therefore, the anti-rotation pin 36 serves as an indicator to visually conform the position of the needle valve element 41 in the direction of the forward/backward motion.

The original-position detection pin 37 is used to set an original position of the needle valve element 41 in the forward/backward direction, the details of which are as below. A photosensor 38 fixed to the side surface of the cylinder housing 32 is provided with a detection part 381 inserted in the cylinder housing 32. When the position of the original-position detection pin 37 in the vertical direction overlaps with the position of the detection part 381, the detection part 381 detects the original-position detection pin 37. The position of the needle valve element 41 at that time is set as the original position. The position of the needle valve element 41 in the forward/backward direction is controlled based on the relative position from the original position.

In conventional arts, it is common for a needle valve element to have a single pin, which serves as both functions of the anti-rotation pin 36 and the original-position detection pin 37. However, the anti-rotation pin 36 may slide in contact with the slot 325 in association with the forward/backward motion of the needle valve element 41, causing the generation of abrasion powder or particles. Therefore, if a single pin has both functions, the abrasion powder or particles may cause false detection of the photosensor. In contrast, the needle valve 1 in the present embodiment including the anti-rotation pin 36 for preventing rotation and the original-position detection pin 37 for detecting the original position, which are separately provided, will not cause the above-mentioned problems.

Furthermore, the anti-rotation pin 36 and the original-position detection pin 37 are identical components and arranged at intervals of 180° in the circumferential direction of the increased-diameter part 414. Thus, each of two pins 36 and 37 can be used as the anti-rotation pin and also as the original-position detection pin. Therefore, it is not necessary to pay attention to the orientation of the needle valve element 41 when the needle valve 1 is assembled.

### Connection between Shaft and Needle Valve Element

The needle valve 1 configured as above can connect the shaft 33 and the needle valve element 41 while minimizing misalignment between the central axis of the shaft 33 and the central axis of the needle valve element 41. This is because, during assembling of the needle valve 1, the motor 31 is positioned in place such that the shaft 33 is coaxial with the annular valve seat 24, and the needle valve element 41 is positioned in place such that the needle valve element 41 (i.e., the body part 411) is coaxial with the annular valve seat 24. The details thereof are as below.

The positioning of the motor 31 will be described first. When the motor 31 is mounted on the upper end face of the cylinder housing 32 and before being fixed with the mounting metal piece 34, the positioning part 314 of the motor 31 is positioned concentrically with the positioning groove 322 of the cylinder housing 32 by the elastic force of the O-ring 76. Since the positioning part 314 is located coaxially with the shaft 33, when the positioning part 314 is positioned concentrically with the positioning groove 322, the positioning groove 322 and the shaft 33 are positioned coaxially. Further, the positioning groove 322 is positioned coaxially with the annular valve seat 24 when the protruding part 323 of the cylinder housing 32 engages with the valve body 20. Therefore, the shaft 33, which is positioned coaxially with the positioning groove 322, is also positioned coaxially with the annular valve seat 24. Thus, the motor 31 is fixed, as described above, to the upper end face of the cylinder housing 32 with the mounting metal piece 34 while the shaft 33 is positioned coaxially with the annular valve seat 24 by the elastic force of the O-ring 76.

The positioning of the needle valve element 41 will be described below. When the needle valve element 41 is inserted in the guide part 26, the needle valve element 41 (the body part 411) is positioned to be concentric with the guide part 26 by the elastic forces of the O-ring 65A and the O-ring 65B. Since the guide part 26 is located coaxially with the annular valve seat 24, the needle valve element 41 (the body part 411) being positioned concentrically with the guide part 26 is positioned coaxially with the annular valve seat 24. As above, the elastic forces of the O-rings 65A and 65B act to position the needle valve element 41 (the body part 411) coaxially with the annular valve seat 24. Further, since the O-ring 65A and the O-ring 65B, which are identical components, are arranged coaxially with each other and side by side in the same direction as the forward/backward motion of the needle valve element 41, the needle valve element 41 can be positioned in place without tilting the central axis of the needle valve element 41 with respect to the vertical direction.

In the above manner, the motor 31 is positioned so that the shaft 33 is coaxial with the annular valve seat 24 and the needle valve element 41 is positioned so that the needle valve element 41 (the body part 411) is coaxial with the annular valve seat 24. Therefore, it is possible to connect the shaft 33 and the needle valve element 41 while minimizing the misalignment between the central axis of the shaft 33 and the central axis of the needle valve element 41.

However, it is conceivable that the central axis of the shaft 33 and the central axis of the needle valve element 41 are misaligned and not positioned coaxially due to manufacturing tolerances. However, the needle valve element 41 has a degree of freedom with respect to the shaft 33 in the perpendicular direction to the vertical direction in FIG. 1 and FIG. 2, i.e., in the radial direction orthogonal to the central axis of the male screw part 331. This degree of freedom allows for the absorption of misalignment between their central axes.

As described above, the shaft 33 and the needle valve element 41 can be connected to each other with minimized misalignment between the central axis of the shaft 33 and the central axis of the needle valve element 41 and further the degree of freedom of the needle valve element 41 with respect to the shaft 33 absorbs the misalignment between their central axes, so that it is possible to suppress the occurrence of problems caused by the central axis misalignment. The problems by the central axis misalignment include an increase in load on the motor 31 due to an increase in sliding resistance between the needle valve element 41 and the guide part 26 and a deterioration in sealing performance and uneven abrasion due to non-uniform compression of the O-rings 65A and 65B over their entire circumference.

### Operations of Needle Valve

The needle valve 1 operates as below. The operation of reducing the opening degree of the needle valve 1 will be described first. The shaft 33 of the motor 31 is controlled based on the number of steps input to the drive circuit 312, as described above. When the shaft 33 is moved in the protruding direction, i.e., in the downward direction in FIG. 1, the needle valve element 41 is moved together with the shaft 33 in a direction to come close to the annular valve seat 24, i.e., in the valve-closing direction. Thus, the clearance between the reduced-diameter part 412 of the needle valve element 41 and the annular valve seat 24, i.e., the opening degree of the needle valve 1, is reduced, thereby decreasing the flow rate of a control fluid allowed to flow to the outflow passage 23.

The operation of increasing the opening degree of the needle valve 1 will be described below. The shaft 33 of the motor 31 is controlled based on the number of steps input to the drive circuit 312, as in the operation of reducing the opening degree. When the shaft 33 is moved in the retracting direction, i.e., in the upward direction in FIG. 1 and FIG. 2, the needle valve element 41 is lifted upward by the shaft 33 and moved in a direction to separate from the annular valve seat 24, i.e., in the valve-opening direction. At that time, even if the O-rings 65A and 65B stick to the inner peripheral surface of the guide part 26, the shaft 33 and the needle valve element 41, which are connected by threaded engagement of the male screw part 331 and the female screw part 413, can be reliably lifted upward. When the needle valve element 41 is moved in the valve-opening direction, the clearance between the reduced-diameter part 412 of the needle valve element 41 and the annular valve seat 24, i.e., the opening degree of the needle valve 1, is increased, thereby increasing the flow rate of the control fluid allowed to flow to the outflow passage 23.

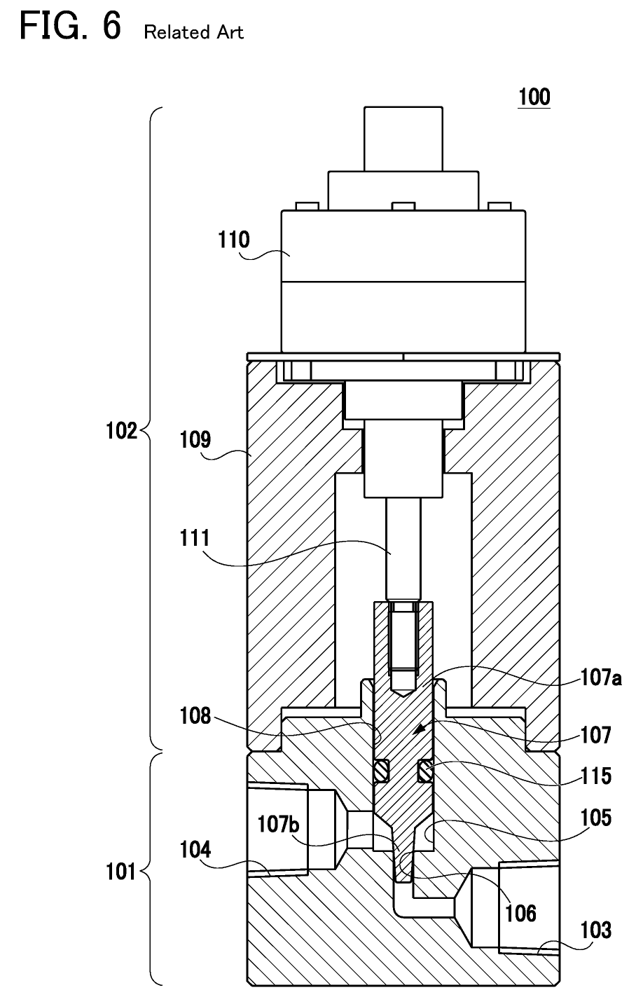

Since the shaft 33 and the needle valve element 41 are connected by threaded engagement of the male screw part 331 and the female screw part 413, the needle valve element 41 has a play (backlash) in the direction of the forward/backward motion, i.e., in the vertical direction, with respect to the shaft 33. This raises a concern that the forward/backward motion of the needle valve element 41 may lag behind the linear motion of the shaft 33 just by the size of the backlash. However, the needle valve 1 in the present embodiment includes the compression coil spring 35, and the needle valve element 41 is constantly urged in the direction toward the shaft 33 by the compression coil spring 35. In addition, the needle valve element 41 is also urged toward the shaft 33 by the fluid pressure of the control fluid flowing in through the inflow passage 21. Thus, the forward/backward motion of the needle valve element 41 is performed without delay from the linear motion of the shaft 33, as with the rigid connecting type needle valve 100 (see FIG. 6). It is therefore possible to suppress the accuracy of regulating the flow rate of the control fluid from decreasing due to the delay of the forward/backward motion of the needle valve element 41.

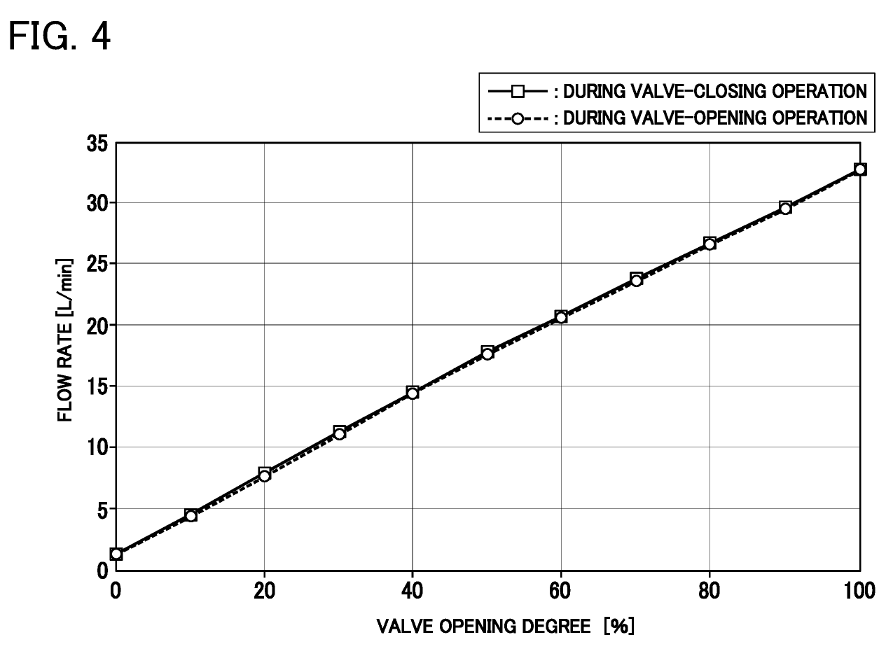

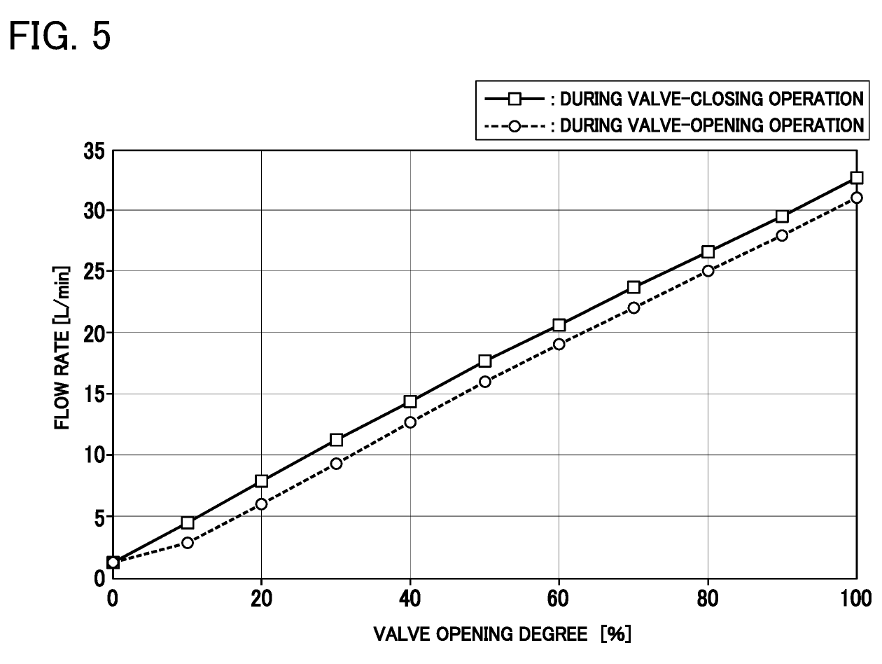

This suppression of a decrease in flow rate regulating accuracy will be further described with reference to graphs in FIG. 4 and FIG. 5. FIG. 4 is a graph showing the flow rate characteristics of the needle valve 1 in the present embodiment. FIG. 5 is a graph showing the flow rate characteristics of the needle valve 1 in the present embodiment for a configuration not including the compression coil spring 35. In both graphs, the “flow rate” in the vertical axis represents the flow rate of a control fluid to be output from the needle valve 1 and the “valve opening degree” in the horizontal axis represents a command value of the opening degree, i.e., the number of steps, input to the drive circuit 312. In the graphs, a plot labeled “during valve-closing operation” shows variations in the flow rate of the control fluid when the needle valve 1 is operated from the maximum valve-open state (opening degree: 100%) to the valve-closed state (opening degree: 0%). A plot labeled “during valve-opening operation” shows variations in the flow rate of the control fluid when the needle valve 1 is operated from the valve-closed state (opening degree: 0%) to the maximum valve-open state (opening degree: 100%).

In the needle valve 1 in the present embodiment, as shown in FIG. 4, the plot during the valve-closing operation and the plot during the valve-opening operation almost overlap each other, and the hysteresis is reduced. Accordingly, regardless of whether the needle valve 1 is in the valve-opening operation or in the valve-closing operation, it is possible to accurately obtain the flow rate corresponding to the specified opening degree. Specifically, for example, when an opening degree of 40% is specified, regardless of whether this opening degree is achieved by the valve-opening operation or the valve-closing operation, a flow rate of about 15 L/min, corresponding to the opening degree of 40%, can be accurately obtained.

In contrast, when the compression coil spring 35 is absent, as shown in FIG. 5, the flow rate characteristics during the valve-closing operation are substantially the same as the flow rate characteristics of the needle valve 1 in the present embodiment, but the flow rate during the valve-opening operation is smaller than the flow rate obtained during the valve-closing operation. This is conceivably because the needle valve element 41 cannot fully follow the movement of the shaft 33 in the retracting direction due to the backlash and thus the actual opening degree is smaller than the commanded opening degree. When such a hysteresis occurs, the obtained flow rate changes depending on whether the needle valve 1 operates toward the opening degree specified for the valve-opening operation or operates toward the opening degree specified for the valve-closing operation. In other words, this may deteriorate the accuracy of regulating the flow rate of a control fluid, which is undesirable.

### Operations and Effects

The needle valve 1 in the present embodiment, as described above, is configured as below.

(1) The valve apparatus (the needle valve 1) includes the drive source (e.g., the linear stepping motor 31) that has the shaft 33 and causes the shaft 33 to linearly move, the annular valve seat 24 whose central axis is parallel to the direction of the linear motion of the shaft 33, and the valve element (e.g., the needle valve element 41) configured to perform the forward/backward motion in the same direction as the linear motion of the shaft 33 with respect to the annular valve seat 24 in accordance with the linear motion of the shaft 33. The shaft 33 and the valve element (e.g., the needle valve element 41) are connected to each other by engagement between the first engagement part (e.g., the male screw part 331) of the shaft 33 and the second engagement part (e.g., the female screw part 413) of the valve element (e.g., the needle valve element 41) with a degree of freedom in at least the perpendicular direction to the direction of the linear motion of the shaft 33 (e.g., in the radial direction orthogonal to the axis of the male screw part 331).

(2) In the valve apparatus (e.g., the needle valve 1) described in (1), the first engagement part is one (the male screw part 331) of the male screw or the female screw, the second engagement part is the other (the female screw part 413) of the male screw or the female screw, and the first engagement part (the male screw part 331) and the second engagement part (the female screw part 413) are connected by threaded engagement with a play, or clearance, and the degree of freedom is ensured by the play.

The central axis of the shaft 33 and the central axis of the needle valve element 41 are preferably located coaxially. However, it is conceivable that the central axis of the shaft 33 and the central axis of the needle valve element 41 are misaligned and not positioned coaxially due to manufacturing tolerances or other reasons. However, according to the above-described valve apparatus (the needle valve 1), the first engagement part (the male screw part 331) and the second engagement part (the female screw part 413) have a degree of freedom in at least the perpendicular direction (the radial direction orthogonal to the axis of the male screw part 331) to the direction of linear motion of the shaft 33. This degree of freedom can absorb the misalignment between their central axes. Although the present embodiment shows that the first engagement part is a male screw (the male screw part 331) and the second engagement part is a female screw (the female screw part 413), an alternative example may be configured such that the first engagement part is a female screw and and the second engagement part is a male screw so that the first engagement part and the second engagement part are engaged with each other.

(3) In the valve apparatus (the needle valve 1) described in (1) or (2), the first engagement part (the male screw part 331) and the second engagement part (the female screw part 413) are engaged with each other with a degree of freedom (e.g., backlash) in the parallel direction to the direction of the linear motion of the shaft 33. This apparatus includes the urging member (e.g., the compression coil spring 35) for urging the valve element (the needle valve element 41) toward the shaft 33.

According to the valve apparatus (the needle valve 1) described above, it is possible to reduce the hysteresis due to the degree of freedom (e.g., backlash) in the parallel direction to the direction of the linear motion of the shaft 33, and thus suppress a decrease in the accuracy of regulating the flow rate of the control fluid.

(4) In the valve apparatus (the needle valve 1) described in any one of (1) to (3), the positioning groove 322 is provided to position the drive source (the linear stepping motor 31), the positioning groove 322 is the columnar space formed coaxially with the annular valve seat 24, the drive source (the linear stepping motor 31) includes the positioning part 314 having a columnar shape, located on the inner circumference side of the positioning groove 322 and formed coaxially with the shaft 33, and the circular ring-shaped elastic member (the O-ring 76) is provided in the clearance between the inner peripheral surface of the positioning groove 322 and the outer peripheral surface of the positioning part 314.

Since the valve element (the needle valve element 41) advances or retracts with respect to the annular valve seat 24, the central axis of the valve element (the needle valve element 41) and the central axis of the shaft 33 are preferably positioned coaxially with the annular valve seat 24. For this purpose, the valve apparatus (the needle valve 1) described above is configured to position the central axis of the shaft 33 coaxially with the annular valve seat 24. Specifically, the positioning part 314 is positioned concentrically with the positioning groove 322 by the elastic force of the elastic member (the O-ring 76). Since the positioning part 314 is located coaxially with the shaft 33, when the positioning part 314 is positioned concentrically with the positioning groove 322, the positioning groove 322 and the shaft 33 are also positioned coaxially. Furthermore, the positioning groove 322 is positioned coaxially with the annular valve seat 24 and thus the shaft 33 positioned coaxially with this positioning groove 322 is also positioned coaxially with the annular valve seat 24.

(5) In the valve apparatus (the needle valve 1) described in any one of (1) to (4), the guide part 26 is provide to guide the forward/backward motion of the valve element (the needle valve element 41), the guide part 26 is the columnar space formed coaxially with the annular valve seat 24, the valve element (the needle valve element 41) includes the inserted part (e.g., the body part 411) having the columnar shape and being insertable in the guide part 26, and the first elastic seal member (e.g., the O-ring 65A) and the second elastic seal member (e.g., the O-ring 65B), each having a circular ring shape, are located in the clearance between the guide part 26 and the inserted part (the body part 411) and arranged coaxially with each other and side by side in the same direction as the forward/backward motion of the valve element (the needle valve element 41),.

Since the valve element (the needle valve element 41) advances or retracts with respect to the annular valve seat 24, the central axis of the valve element (the needle valve element 41) and the central axis of the shaft 33 are preferably positioned coaxially with the annular valve seat 24. For this purpose, the valve apparatus (the needle valve 1) described above is configured to position the central axis of the valve element (the needle valve element 41) coaxially with the annular valve seat 24. Specifically, when the needle valve element 41 (the body part 411) is inserted in the guide part 26, the inserted part (the body part 411) is positioned concentrically with the guide part 26 by the elastic forces of the first elastic seal member (the O-ring 65A) and the second elastic seal member (the O-ring 65B). Since the guide part 26 is located coaxially with the annular valve seat 24, the needle valve element 41 (the body part 411) being positioned concentrically with the guide part 26 is also positioned coaxially with the annular valve seat 24. Further, since the first elastic seal member (the O-ring 65A) and the second elastic seal member (the O-ring 65B) are arranged coaxially and side by side in the same direction as the forward/backward motion of the needle valve element 41, the needle valve element 41 can be positioned in place without tilting the central axis of the needle valve element 41 with respect to the direction of the forward/backward motion.

(6) In the valve apparatus (the needle valve 1) described in (5), the first elastic seal member (the O-ring 65A) and the second elastic seal member (the O-ring 65B) are preferably arranged side by side in the same direction as the forward/backward motion of the valve element (the needle valve element 41) at a larger distance, or interval, than the stroke amount of the forward/backward motion of the valve element (the needle valve element 41).

To ensure the slidability of the valve element (the needle valve element 41) in the forward/backward motion, a lubricant agent (e.g., grease) is filled in between the first elastic seal member (the O-ring 65A) and the second elastic seal member (the O-ring 65B). The valve apparatus (the needle valve 1) described above can suppress the lubricant agent from leaking to the outside of the first elastic seal member (the O-ring 65A) and the second elastic seal member (the O-ring 65B) by the forward/backward motion of the needle valve element 41.

(7) In the valve apparatus (the needle valve 1) described in (2), the anti-rotation pin 36 protruding from the rotational axis (the central axis) of the valve element (the needle valve element 41) is preferably provided to prevent the valve element (the needle valve element 41) from rotating in the direction of loosening the threaded engagement or the opposite direction to the loosening direction.

(8) In the valve apparatus (the needle valve 1) described in (7), preferably, the anti-rotation pin 36 is exposed to the outside of the valve apparatus (the needle valve 1), and serves as an indicator allowing visual confirmation of the position of the valve element (the needle valve element 41) in the direction of the forward/backward motion of the valve element (the needle valve element 41).

According to the valve apparatus (the needle valve 1) described above, the anti-rotation pin 36 can prevent the rotation of the needle valve element 41 in the loosening direction of the threaded engagement of the male screw part 331 and the female screw part 413 or the opposite direction thereto, and thus can suppress the position of the needle valve element 41 from changing relative to the shaft 33 in the vertical direction. Thus, the needle valve 1 can achieve the enhanced reliability of controlling the opening degree.

The foregoing embodiments are mere examples and give no limitation to the present disclosure. The present disclosure may be embodied in other specific forms without departing from the essential characteristics thereof. For instance, the present embodiment exemplifies the male screw part 331 as the first engagement part and the female screw part 413 as the second engagement part, but not limited thereto. For example, an alternative example may be configured such that the first engagement part is a columnar protrusion protruding from the shaft 33 toward the needle valve element 41, the second engagement part is a recess capable of receiving the protrusion, and a retaining pin is inserted in the perpendicular direction to the axis of the shaft 33 with the protrusion inserted in the recess, thereby connecting the shaft 33 and the needle valve element 41.

The present embodiment exemplifies the O-ring 76 as the elastic member, the O-ring 65A as the first elastic seal member, and the O-ring 65B as the second elastic seal member, but may employ seal members such as rectangular packings.

### Reference Signs List

1 Needle valve

24 Annular valve seat

31 Linear stepping motor

33 Shaft

41 Needle valve element

331 Male screw part

413 Female screw part

What is claimed is:

1. A valve apparatus comprising:
a drive source provided with a shaft and configured to perform a linear motion of the shaft;
an annular valve seat with an axial direction parallel to a direction of the linear motion; and
a valve element configured to perform a forward/backward motion in the same direction as the linear motion with respect to the annular valve seat in accordance with the linear motion,
wherein the shaft and the valve element are connected to each other by engagement of a first engagement part provided in the shaft and a second engagement part provided in the valve element with a degree of freedom in at least a perpendicular direction to the direction of the linear motion.

2. The valve apparatus according to claim 1, wherein
the first engagement part is one of a male screw and a female screw,
the second engagement part is another of the male screw and the female screw, and
the first engagement part and the second engagement part are connected by threaded engagement with a play, and the degree of freedom is ensured by the play.

3. The valve apparatus according to claim 1, wherein
the first engagement part and the second engagement part are engaged with each other with a degree of freedom in a parallel direction to the direction of the linear motion, and
the valve apparatus further includes an urging member for urging the valve element toward the shaft.

4. The valve apparatus according to claim 2, wherein
the first engagement part and the second engagement part are engaged with each other with a degree of freedom in a parallel direction to the direction of the linear motion, and
the valve apparatus further includes an urging member for urging the valve element toward the shaft.

5. The valve apparatus according to claim 1, further including a positioning groove for positioning the drive source, wherein
the positioning groove is a columnar space formed coaxially with the annular valve seat,
the drive source includes a positioning part having a columnar shape, the positioning part being located on an inner circumference side of the positioning groove and formed coaxially with the shaft, and
the valve apparatus is provided with an elastic member having a circular ring shape and being located in a clearance between an inner peripheral surface of the positioning groove and an outer peripheral surface of the positioning part.

6. The valve apparatus according to claim 2, further including a positioning groove for positioning the drive source, wherein
the positioning groove is a columnar space formed coaxially with the annular valve seat,
the drive source includes a positioning part having a columnar shape, the positioning part being located on an inner circumference side of the positioning groove and formed coaxially with the shaft, and
the valve apparatus is provided with an elastic member having a circular ring shape and being located in a clearance between an inner peripheral surface of the positioning groove and an outer peripheral surface of the positioning part.

7. The valve apparatus according to claim 1, further including a guide part for guiding the forward/backward motion of the valve element, wherein
the guide part is a columnar space formed coaxially with the annular valve seat,
the valve element includes an inserted part having a columnar shape and being insertable in the guide part, and
the valve apparatus is provided with a first elastic seal member and a second elastic seal member, each having a circular ring shape, located in a clearance between the guide part and the inserted part, the first elastic seal member and the second elastic seal member being arranged coaxially with each other and side by side in the same direction as the forward/backward motion of the valve element.

8. The valve apparatus according to claim 2, further including a guide part for guiding the forward/backward motion of the valve element, wherein
the guide part is a columnar space formed coaxially with the annular valve seat,
the valve element includes an inserted part having a columnar shape and being insertable in the guide part, and
the valve apparatus is provided with a first elastic seal member and a second elastic seal member, each having a circular ring shape, located in a clearance between the guide part and the inserted part, the first elastic seal member and the second elastic seal member being arranged coaxially with each other and side by side in the same direction as the forward/backward motion of the valve element.

9. The valve apparatus according to claim 7, wherein the first elastic seal member and the second elastic seal member are arranged side by side in the same direction as the forward/backward motion of the valve element at a distance larger than a stroke amount of the forward/backward motion.

10. The valve apparatus according to claim 8, wherein the first elastic seal member and the second elastic seal member are arranged side by side in the same direction as the forward/backward motion of the valve element at a distance larger than a stroke amount of the forward/backward motion.

11. The valve apparatus according to claim 2, wherein the valve element is provided with an anti-rotation pin protruding from an axis of rotation of the valve element to suppress the rotation of the valve element in a loosening direction of the threaded engagement or an opposite direction.

12. The valve apparatus according to claim 11, wherein the anti-rotation pin is exposed to outside of the valve apparatus and serves as an indicator to visually confirm a position of the valve element in the direction of the forward/backward motion.
